(19) United States
(12) Patent Application Publication
(10) Pub. No.: US 2013/0307273 A1
(43) Pub. Date: Nov. 21, 2013

(54) SOLAR ENERGY STORAGE SYSTEM INCLUDING THREE OR MORE RESERVOIRS

(71) Applicants: Leon Afremov, Tel Aviv (IL); Gideon Goldwine, Jerusalem (IL)

(72) Inventors: Leon Afremov, Tel Aviv (IL); Gideon Goldwine, Jerusalem (IL)

(73) Assignee: BRIGHTSOURCE INDUSTRIES (ISRAEL) LTD., Jerusalem (IL)

(21) Appl. No.: 13/977,691

(22) PCT Filed: Nov. 29, 2011
(86) PCT No.: PCT/IB11/55357

§ 371 Date: Jun. 29, 2013

Related U.S. Application Data
(60) Provisional application No. 61/440,454, filed on Feb. 8, 2011.

(51) Int. Cl. H02K 7/18

(52) U.S. Cl. CPC H02K 7/18
USPC 290/52

(57) ABSTRACT

A first period may be characterized by relatively high insolation, while a second period may be characterized by relatively low insolation. At the first period, steam is generated using insolation. A portion of the steam produces electricity, while a second portion of the steam is directed to a heat exchanger in thermal communication with thermal reservoirs. A storage fluid is flowed through the heat exchanger from a first reservoir to a second reservoir and/or from the second reservoir to a third reservoir such that enthalpy in the steam second portion is transferred to the storage fluid. At a second period, the storage fluid is reverse-flowed through the heat exchanger from the third to the second reservoir and/or from the second to the first reservoir such that enthalpy in the storage fluid generates steam to produce electricity. Enthalpy during high insolation periods can thus be stored for use during low insolation periods.

### CROSS-REFERENCE TO RELATED APPLICATIONS

The present application claims the benefit of U.S. Provisional Application No. 61/440,454, filed Feb. 8, 2011, which is hereby incorporated by reference herein in its entirety.

### FIELD

The present disclosure relates generally to the energy production using solar insolation, and, more particularly, to storage of solar energy using at least three thermal storage reservoirs.

### SUMMARY

Insolation can be used to heat a working fluid (e.g., water or carbon dioxide) for use in generating electricity (e.g., via a steam turbine). During periods of relatively higher insolation, there may be excess heat energy (i.e., enthalpy) than that needed for electricity generation. In contrast, during periods of relatively lower insolation (e.g., cloud cover or at night), the enthalpy in the working fluid may be insufficient to generate electricity. In general, during the periods of relatively higher insolation, the excess enthalpy may be stored in a thermal storage system for use, for example, during periods of relatively lower insolation or at times when supplemental electricity generation is necessary (e.g., during peak power periods). The thermal storage system can include at least three separate reservoirs at different temperatures above the melting point of a thermal storage fluid (e.g., a molten salt or metal) contained therein. Enthalpy transfer between the thermal storage fluid and the working fluid occurs by way of a heat exchanger in thermal communication with a flow path of the storage fluid between each of the reservoirs.

In one or more embodiments, a method of generating electricity using insolation can include at least first and second operating periods. At a first operating period, the method can include generating steam using insolation and using a portion of the generated steam to drive a turbine so as to produce electricity. Another portion of the generated steam can be directed to a heat exchanger in thermal communication with first through third thermal reservoirs, and at a same time, a storage fluid can be flowed from the first reservoir through the heat exchanger to the second reservoir and from the second reservoir through the heat exchanger to the third reservoir such that enthalpy in the another portion of the generated steam is transferred to the storage fluid by way of the heat exchanger. At a second operating period, the method can include reverse-flowing the storage fluid from the third reservoir through the heat exchanger to the second reservoir and from the second reservoir through the heat exchanger to first reservoir such that enthalpy in the storage fluid is transferred by way of the heat exchanger to generate steam. The steam generated by the reverse-flowing can be used to drive the turbine to produce electricity. A temperature of the third reservoir can be maintained higher than a temperature of the second reservoir, and a temperature of second reservoir can be maintained higher than a temperature of the first reservoir.

In one or more embodiments, a system for generating electricity from insolation can include a solar collection system, a thermal storage system, an electricity generating system, and a heat exchanger. The solar collection system can be constructed so as to generate steam from insolation. The thermal storage system can include first through third thermal storage reservoirs. The electricity generating system can include a turbine that uses steam to generate electricity and can be coupled to the solar collection system so as to receive generated steam therefrom. The heat exchanger can thermally couple the solar collection system and the thermal storage system such that enthalpy in fluid in one of the solar collection and thermal storage systems can be transferred to fluid in the other of the solar collection and thermal storage systems. The first through third storage reservoirs can be connected in order such that fluid flowing between the first and second reservoirs and between the second and third reservoirs passes through the heat exchanger.

In one or more embodiments, a method for thermal storage for electricity generation can include, during a first time, producing electricity using steam generated by discharging stored enthalpy from a thermal storage system via a heat exchanger. The thermal storage system can include three storage reservoirs that can contain storage fluid at different temperatures. A temperature of storage fluid in the first reservoir can be less than a temperature of storage fluid in the second reservoir. A temperature of storage fluid in the second reservoir can be less than a temperature of storage fluid in the third reservoir. The first through third reservoirs can be connected together in order such that storage fluid can flow between the first and second reservoirs and between the second and third reservoirs. The stored enthalpy can be derived from steam generated using insolation.

In one or more embodiments, a method can include, at some times, using insolation to generate saturated steam from pressurized liquid water at a pressure P and subjecting some of the saturated steam to a heat transfer operation whereby enthalpy of the saturated steam is conductively and/or convectively transferred to a thermal storage fluid to heat the storage fluid to the evaporation temperature Tₑᵥ and to condense the saturated steam. The pressurized steam can be substantially at the evaporation temperature Tₑᵥ of water for the pressure P. In addition, insolation can be used to superheat some of the saturated steam by a least 50° C. to obtain superheated steam whose temperature is Tₛᵤₚ, and subjecting some of the superheated steam to a heat transfer operation whereby enthalpy of the superheated steam is conductively and/or convectively transferred to the thermal storage fluid at the evaporation temperature Tₑᵥ to further heat the thermal storage fluid to substantially the temperature Tₛᵤₚ. Some of the superheated steam can be used to drive a steam turbine. The method can further include, at other times, transforming enthalpy from the thermal storage fluid at the temperature Tₑᵥ to liquid water pressurized to the pressure P to generate saturated steam at the pressure P and to cool the thermal storage fluid, and transforming enthalpy from the thermal storage fluid at the temperature Tₛᵤₚ to the saturated steam to heat the steam to substantially Tₛᵤₚ.

In one or more embodiments, a multi-reservoir thermal storage system for storing a molten salt and/or molten metal thermal storage fluid can include a plurality of substantially insulated reservoirs and a control system. The plurality of substantially insulated reservoirs can include first, second, and third reservoirs. The reservoirs can be in fluid communication with each other. The control system can be configured to regulate flow of the thermal storage fluid between the reservoirs to transform the thermal storage system from a substantially uncharged state to a substantially charged state. In the substantially uncharged state, substantially all of the storage fluid in the thermal storage system is in the first reservoir at a first temperature T₁ that exceeds a melting point of the thermal storage fluid. The thermal storage fluid can travel between reservoirs and be heated en route by at least partial thermal contact with solar-generated steam and/or subcritical carbon dioxide. In the substantially charged state, at most a small minority of the storage fluid in the thermal storage system is in the first reservoir, a majority of the storage fluid in the thermal storage system is in the second reservoir at a second temperature T₂ exceeding the first temperature T₁, and a minority of the storage fluid in the thermal storage system is in the third reservoir at a third temperature T₃ exceeding the second temperature T₂. The third temperature T₃ can be below a boiling point of the thermal storage fluid. When in the charged state, a ratio between an amount of storage fluid within the second reservoir and an amount of storage fluid in the third reservoir is at least 1.5 and at most 10, a difference between T₂ and T₁ is at least 20° C., and a ratio between (T₃−T₂) and (T₂−T₁) is at least 1.5 and at most 10.

In one or more embodiments, a method of storing enthalpy in a thermal storage fluid can include harvesting enthalpy of a quantity of supercritical steam whose temperature exceeds the critical temperature of water by T_{Diff}_{_{—}}₁ to cool the supercritical steam into pressurized water whose temperature is below a critical temperature by at least T_{Diff}_{_{—}}₃, and employing the harvested enthalpy to heat thermal storage fluid. The thermal storage fluid can include molten metal or molten salt. An initial temperature of the quantity of thermal storage fluid can be below the critical temperature of water by T_{Diff}_{_{—}}₄. A first portion of the thermal storage fluid quantity can be heated by the employing to a first destination temperature, and a second portion of the thermal storage fluid quantity can be heated by the employing to a second destination temperature that exceeds the critical temperature of water by T_{Diff}_{_{—}}₂. T_{Diff}_{_{—}}₃ and T_{Diff}_{_{—}}₄ can be at least 25° C., and a ratio between T_{Diff}_{_{—}}₂ and T_{Diff}_{_{—}}₁ can be at least 0.5.

In one or more embodiments, a thermal energy storage system can be configured to store enthalpy received from a steam system. The thermal energy storage system can include first, second, and third reservoirs, a thermal storage fluid, and a control apparatus. Each of the second and third reservoirs can be in fluid communication with the first reservoir. The thermal storage fluid can include at least one of molten salt and molten metal. The control apparatus can be configured to regulate flow parameters and/or heat transfer parameters of the thermal storage fluid so as to effect a state transition between the first and second states of the thermal storage system using enthalpy. The first state can be a lower-enthalpy state in which substantially all of the thermal storage fluid is located in the first reservoir at a first temperature T₁. The second state can be a higher-enthalpy state in which substantially none of the thermal storage fluid is located in the first reservoir. A first fraction, F₁, of the thermal storage fluid can reside in the second reservoir at a second temperature, T₂, in the second state, and a second fraction, F₂, of the thermal storage fluid can resides in the third reservoir at a third temperature, T₃, in the second state. T₃ can be greater than T₂, which can be greater than T₁. T₁ can exceed the freezing point of the thermal storage fluid. The sum of F₁ and F₂ can be substantially equal to 1. F₁ can be greater than F₂. The control apparatus can be configured such that the enthalpy for the transition between the first and second states is supplied in a heat exchange process whereby steam of said steam system is cooled into pressurized water.

In one or more embodiments, a thermal energy storage system can include three reservoirs of a liquid. When the system is substantially uncharged, a first reservoir can contain substantially all of the liquid at a first temperature. When the system is substantially charged, the first reservoir can be substantially empty, a second reservoir can contain a first portion of the liquid at a second temperature, and a third reservoir can contain a second portion of the liquid at a third temperature. The first and second portions can comprise substantially all of the liquid in the system. When the system is charging or discharging, the liquid can be in thermal communication with a pressurized working fluid by way of a heat exchanger. The pressurized working fluid can be in a liquid phase at the end of the charging or at the beginning of the discharging. The pressurized working fluid can be in a gas phase at the end of the discharging and supercritical at the beginning of charging. The first temperature can be above the freezing point of the liquid, the second temperature can be greater than the first temperature, and the third temperature can be greater than the second temperature. The first portion of the liquid can be greater by mass than the second portion of the liquid.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1 shows a solar power tower system, according to one or more embodiments of the disclosed subject matter.

FIG. 2 shows another solar power tower system with secondary reflector, according to one or more embodiments of the disclosed subject matter.

FIG. 3 shows a solar power tower system including multiple towers, according to one or more embodiments of the disclosed subject matter.

FIG. 4 shows a solar power tower system including multiple receivers in a single tower, according to one or more embodiments of the disclosed subject matter.

FIG. 5 is a schematic diagram of a heliostat control system, according to one or more embodiments of the disclosed subject matter.

FIG. 6A is a simplified diagram showing a first arrangement for and connections between the storage reservoirs of a thermal storage system, according to one or more embodiments of the disclosed subject matter.

FIG. 6B is a simplified diagram showing alternative connections between the storage reservoirs of a thermal storage system, according to one or more embodiments of the disclosed subject matter.

FIG. 7A is a simplified diagram showing a modification of the system of FIG. 6B with a bypass line between cold and hot reservoirs, according to one or more embodiments of the disclosed subject matter.

FIG. 7B is a simplified diagram showing a modification of the system of FIG. 7A without a connection between the warm and hot reservoirs, according to one or more embodiments of the disclosed subject matter.

FIG. 8 is a flow diagram illustrating an exemplary method of charging and discharging a thermal storage system, according to one or more embodiments of the disclosed subject matter.

FIG. 9 is a simplified diagram showing the interaction between an solar collection system (SCS), a thermal storage system (TSS), and an electricity generation system (EGS) during a charging mode, according to one or more embodiments of the disclosed subject matter.

FIG. 10 is a simplified diagram showing the interaction between an solar collection system (SCS), a thermal storage system (TSS), and an electricity generation system (EGS) during a discharging mode, according to one or more embodiments of the disclosed subject matter.

FIG. 11 shows a configuration for various components of a solar collection system, a thermal storage system, and an electricity generation system, according to one or more embodiments of the disclosed subject matter.

FIG. 12 shows isobaric temperature-heat flow curves for water, according to one or more embodiments of the disclosed subject matter.

FIG. 13A shows temperature-heat flow curves for a working fluid and a thermal storage fluid and various temperature relationships, according to one or more embodiments of the disclosed subject matter.

FIG. 13B shows exemplary temperature-heat flow curves for a working fluid and thermal storage fluid during charging and discharging modes, according to one or more embodiments of the disclosed subject matter.

FIG. 14A shows another configuration for various components of a solar collection system, a thermal storage system, and an electricity generation system during a charging mode, according to one or more embodiments of the disclosed subject matter.

FIG. 14B shows the configuration of FIG. 14A during a discharging mode, according to one or more embodiments of the disclosed subject matter.

### DETAILED DESCRIPTION

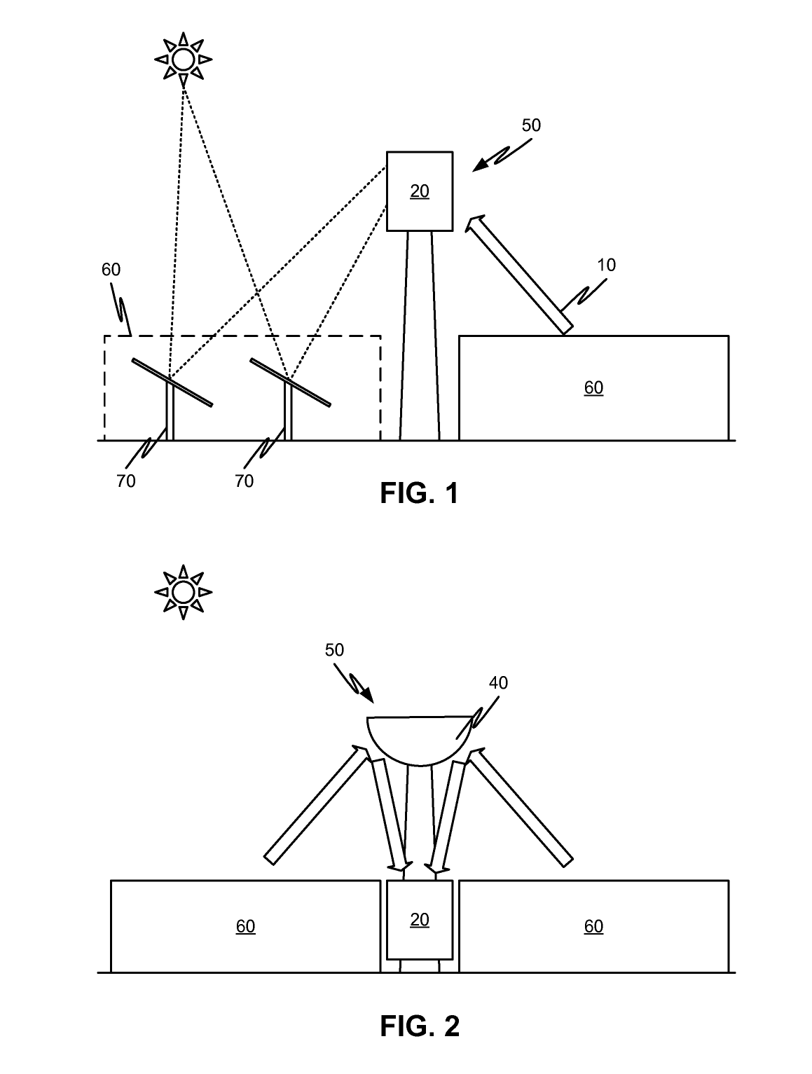

Insolation can be used by a solar tower system to generate solar steam and/or for heating molten salt. In FIG. 1, a solar tower system can include a solar tower 50 that receives reflected focused sunlight 10 from a solar field 60 of heliostats (individual heliostats 70 are illustrated in the left-hand portion of FIG. 1 only). For example, the solar tower 50 can have a height of at least 25 meters, 50 meters, 75 meters, or higher. The heliostats 70 can be aimed at solar energy receiver system 20, for example, a solar energy receiving surface of one or more receivers of system 20. Heliostats 70 can adjust their orientation to track the sun as it moves across the sky, thereby continuing to reflect sunlight onto one or more aiming points associated with the receiver system 20. A solar energy receiver system 20, which can include one or more individual receivers can be mounted in or on solar tower 50. The solar receivers can be constructed to heat water and/or steam and/or supercritical steam and/or any other type of heat transfer/working fluid using insolation received from the heliostats. Alternatively or additionally, the target or receiver 20 can include, but is not limited to, a photovoltaic assembly, a steam-generating assembly (or another assembly for heating a solid or fluid), a biological growth assembly for growing biological matter (e.g., for producing a biofuel), or any other target configured to convert focused insolation into useful energy and/or work.

The solar energy receiver system 20 can be arranged at or near the top of tower 50, as shown in FIG. 1. In another embodiment, a secondary reflector 40 can be arranged at or near the top of a tower 50, as shown in FIG. 2. The secondary reflector 40 can thus receive the insolation from the field of heliostats 60 and redirect the insolation (e.g., through reflection) toward a solar energy receiver system 20. The solar energy receiver system 20 can be arranged within the field of heliostats 60, outside of the field of heliostats 60, at or near ground level, at or near the top of another tower 50, above or below reflector 40, or elsewhere.

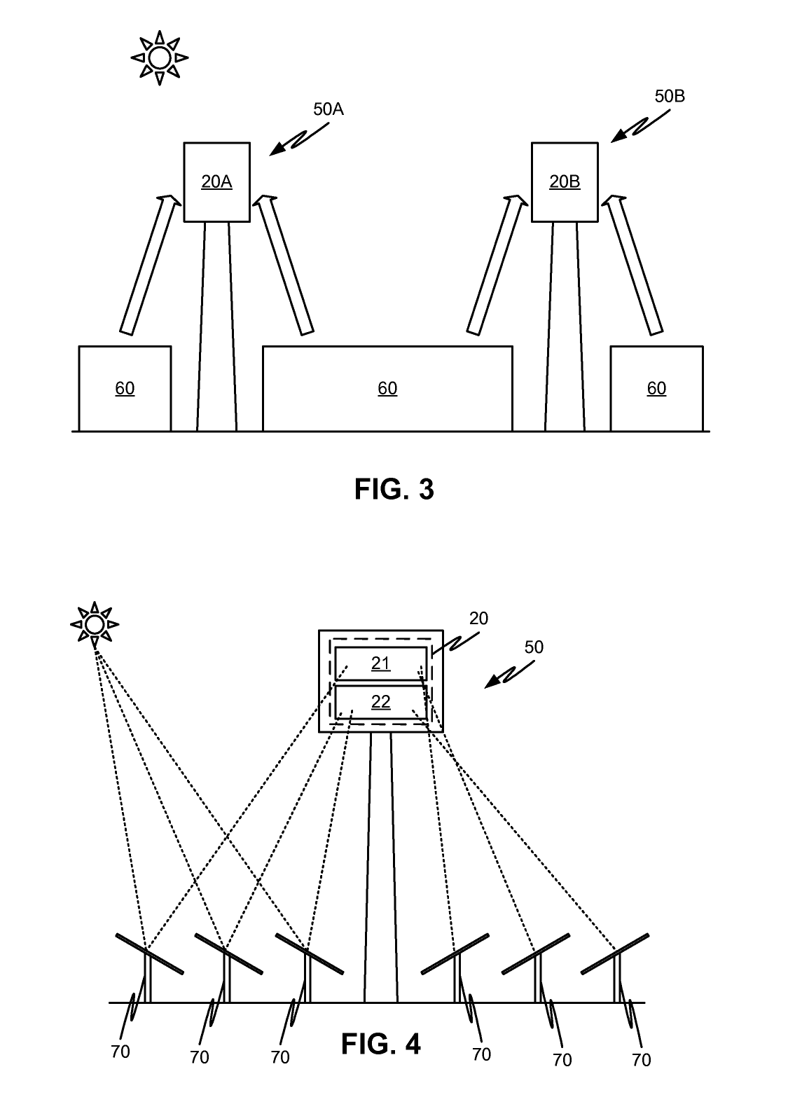

More than one solar tower 50 can be provided, each with a respective solar energy receiving system thereon, for example, a solar power steam system. The different solar energy receiving systems may have different functionalities. For example, one of the solar energy receiving systems may heat water using the reflected solar radiation to generate steam while another of the solar energy receiving systems may serve to superheat steam using the reflected solar radiation. The multiple solar towers 50 may share a common heliostat field 60 or have respective separate heliostat fields. Some of the heliostats may be constructed and arranged so as to alternatively direct insolation at solar energy receiving systems in different towers. In addition, the heliostats may be configured to direct insolation away from any of the towers, for example, during a dumping condition. As shown in FIG. 3, two solar towers can be provided, each with a respective solar energy receiving system. A first tower 50A has a first solar energy receiving system 20A while a second tower 50B has a second solar energy receiving system 20B. The solar towers 50A, 50B are arranged so as to receive reflected solar radiation from a common field of heliostats 60. At any given time, a heliostat within the field of heliostats 60 may be directed to a solar receiver of any one of the solar towers 50A, 50B. Although only two solar towers with respective solar energy receiving systems are shown in FIG. 3, any number of solar towers and solar energy receiving systems can be employed.

More than one solar receiver can be provided on a solar tower. The multiple solar receivers in combination may form a part of the solar energy receiving system 20. The different solar receivers may have different functionalities. For example, one of the solar receivers may heat water using the reflected solar radiation to generate steam while another of the solar receivers may serve to superheat steam using the reflected solar radiation. The multiple solar receivers can be arranged at different heights on the same tower or at different locations (e.g., different faces, such as a north face, a west face, etc.) on the same tower. Some of the heliostats in field 60 may be constructed and arranged so as to alternatively direct insolation at the different solar receivers. As shown in FIG. 4, two solar receivers can be provided on a single tower 50. The solar energy receiving system 20 thus includes a first solar receiver 21 and a second solar receiver 22. At any given time, a heliostat 70 may be aimed at one or both of the solar receivers, or at none of the receivers. In some use scenarios, the aim of a heliostat 70 may be adjusted so as to move a centroid of the reflected beam projected at the tower 50 from one of the solar receivers (e.g., 21) to the other of the solar receivers (e.g., 22). Although only two solar receivers and a single tower are shown in FIG. 4, any number of solar towers and solar receivers can be employed.

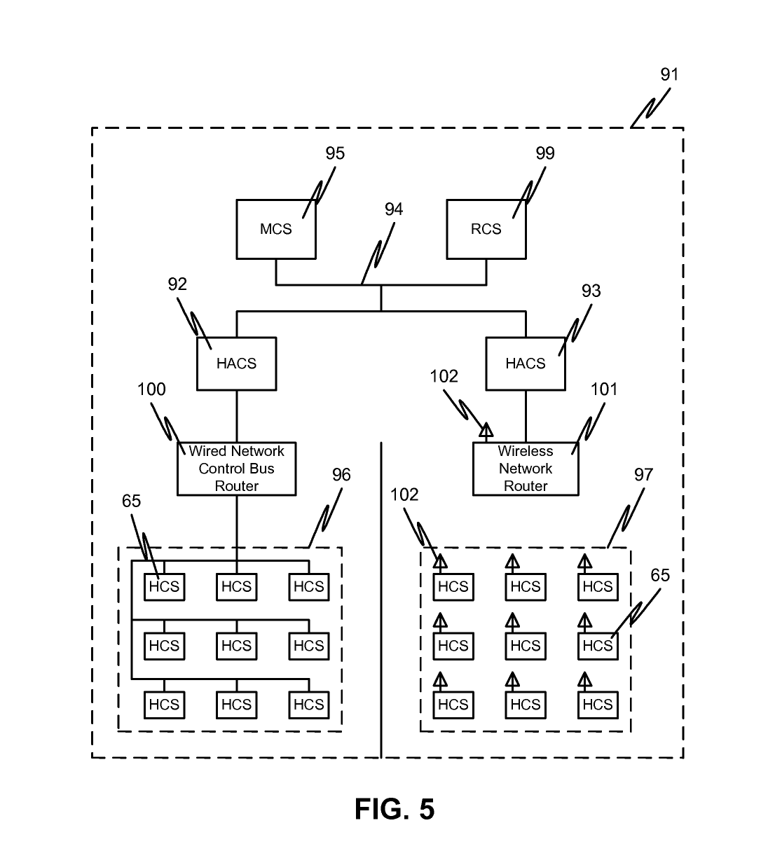

Heliostats 70 in a field 60 can be controlled through a central heliostat field control system 91, for example, as shown in FIG. 5. For example, a central heliostat field control system 91 can communicate hierarchically through a data communications network with controllers of individual heliostats. FIG. 5 illustrates a hierarchical control system 91 that includes three levels of control hierarchy, although in other implementations there can be more or fewer levels of hierarchy, and in still other implementations the entire data communications network can be without hierarchy, for example, in a distributed processing arrangement using a peer-to-peer communications protocol.

At a lowest level of control hierarchy (i.e., the level provided by heliostat controller) in the illustration there are provided programmable heliostat control systems (HCS) 65, which control the two-axis (azimuth and elevation) movements of heliostats (not shown), for example, as they track the movement of the sun. At a higher level of control hierarchy, heliostat array control systems (HACS) 92, 93 are provided, each of which controls the operation of heliostats 70 (not shown) in heliostat fields 96, 97, by communicating with programmable heliostat control systems 65 associated with those heliostats 70 through a multipoint data network 94 employing a network operating system such as CAN, Devicenet, Ethernet, or the like. At a still higher level of control hierarchy a master control system (MCS) 95 is provided which indirectly controls the operation of heliostats in heliostat fields 96, 97 by communicating with heliostat array control systems 92, 93 through network 94. Master control system 95 further controls the operation of a solar receiver (not shown) by communication through network 94 to a receiver control system (RCS) 99.

In FIG. 5, the portion of network 94 provided in heliostat field 96 can be based on copper wire or fiber optic connections, and each of the programmable heliostat control systems 65 provided in heliostat field 96 can be equipped with a wired communications adapter, as are master control system 95, heliostat array control system 92 and wired network control bus router 100, which is optionally deployed in network 94 to handle communications traffic to and among the programmable heliostat control systems 65 in heliostat field 96 more efficiently. In addition, the programmable heliostat control systems 65 provided in heliostat field 97 communicate with heliostat array control system 93 through network 94 by means of wireless communications. To this end, each of the programmable heliostat control systems 65 in heliostat field 97 is equipped with a wireless communications adapter 102, as is wireless network router 101, which is optionally deployed in network 94 to handle network traffic to and among the programmable heliostat control systems 65 in heliostat field 97 more efficiently. In addition, master control system 95 is optionally equipped with a wireless communications adapter (not shown).

Insolation can vary both predictably (e.g., diurnal variation) and unpredictably (e.g., due to cloud cover, dust, solar eclipses, or other reasons). During these variations, insolation may be reduced to a level insufficient for heating a working or heat transfer fluid, for example, producing steam for use in generating electricity. To compensate for these periods of reduced insolation, or for other reasons disclosed herein, thermal energy produced by the insolation can be stored in a fluid-based thermal storage system for use later when needed. The thermal storage system can store energy when insolation is generally available (i.e., charging the thermal storage system) and later release the energy to heat a working fluid (e.g., water or carbon dioxide) in addition to or in place of insolation. For example, it may be possible at night to replace the radiative heating of the working fluid in the solar collection system by insolation with conductive and/or convective heat transfer of thermal energy (i.e., enthalpy) from thermal storage system to the working fluid in the solar collection system. Although the term working fluid is used herein to refer to the fluid heated in the solar collection system, it is not meant to require that the working fluid actually be used to produce work (e.g., by driving a turbine). For example, the working fluid as used herein may release heat energy stored therein to another fluid which may in turn be used to produce useful work or energy. The working fluid may thus act as a heat transfer fluid. Working fluid and heat transfer fluid has been interchangeably used herein to refer to the fluid heated by the solar collection system

In one or more embodiments, the thermal storage system includes at least three separate thermal storage reservoirs, which can be substantially insulated to minimize heat loss therefrom. A thermal storage fluid can be distributed among the three storage reservoirs. For example, the thermal storage fluid can be a molten salt and/or molten metal and/or other high temperature (i.e., >250° C.) substantially liquid medium. The thermal storage fluid can be heated by convective or conductive heat transfer between the working fluid and the thermal storage fluid in a heat exchanger. This net transfer of enthalpy to the thermal storage fluid in the thermal storage system is referred to herein as charging the thermal storage system. At a later time when insolation decreases, the direction of heat exchange can be reversed to transfer enthalpy from the thermal storage fluid to the working fluid via the same or a different heat exchanger. This net transfer of enthalpy from the thermal storage fluid of the thermal storage system is referred to herein as discharging the thermal storage system.

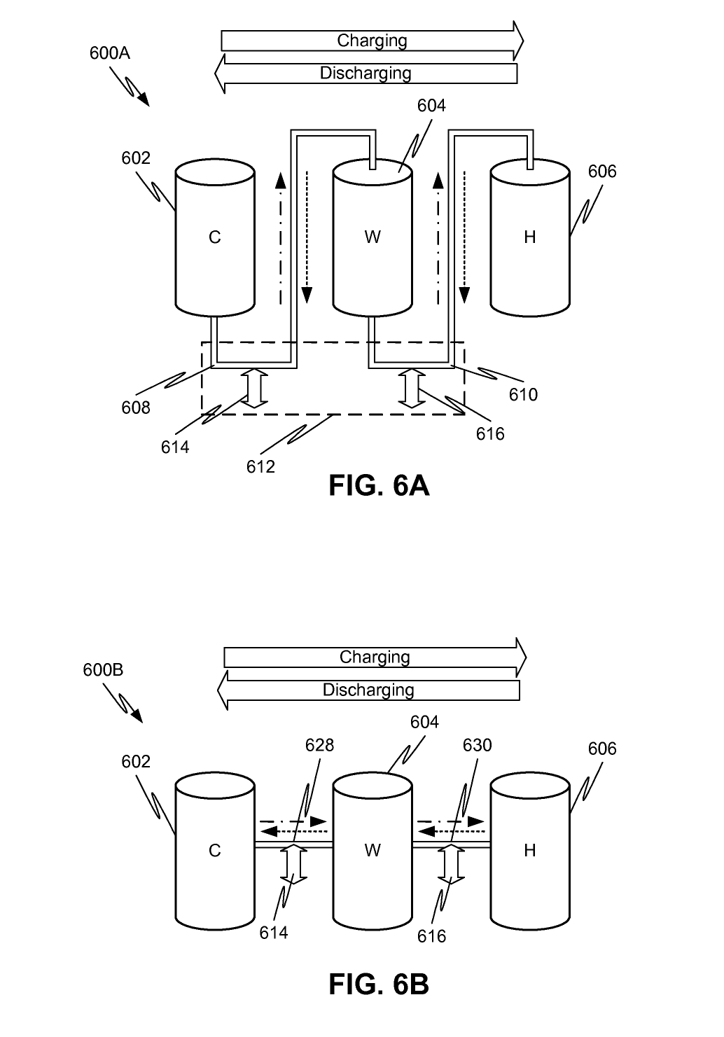

Each thermal storage reservoir can be, for example, a fluid tank or a below-grade pool. Referring to FIG. 6A, a thermal storage system 600A with fluid tanks as the thermal storage reservoir is shown. A first fluid tank 602 can be considered a relatively cold reservoir, in that the temperature during the charging and/or discharging modes is maintained at substantially a temperature of T_{C}, which is the lowest temperature in the thermal storage system. A second fluid tank 604 can be considered a relatively warm reservoir, in that the temperature during the charging and/or discharging modes is maintained at substantially a temperature of T_{W}, which is a middle temperature in the thermal storage system. A third fluid tank 606 can be considered a relatively hot reservoir, in that the temperature during the charging and/or discharging modes is maintained at substantially a temperature of T_{H}, which is the highest temperature in the thermal storage system.

During the charging phase (flow directions illustrated by dash-dot lines in the figure), thermal storage fluid can be transferred from the colder reservoirs of the thermal storage system to the hotter reservoirs of the thermal storage system, as designated by the block arrow in FIG. 6A. During the discharging phase (flow directions illustrated by dotted lines in the figure), the flow of thermal storage fluid can be reversed so as to flow from the hotter reservoirs to the colder reservoirs of the thermal storage system, as designated by the block arrow in FIG. 6A. Thus, fluid in the first reservoir 602 can be transferred via fluid conduit or pipe 608 to the second reservoir 604 in the charging phase and reversed in the discharging phase. Likewise, any fluid in the second reservoir 604 can be transferred via fluid conduit or pipe 610 to the third reservoir 606 in the charging phase and reversed in the discharging phase.

During the charging or discharging modes, enthalpy can be exchanged between the working fluid and the thermal storage fluid as the thermal storage fluid passes between the reservoirs. The fluid conduits or pipes can be in thermal communication with the working fluid by way of a heat exchanger to allow the transfer of enthalpy as the thermal storage fluid flows between reservoirs (i.e., while the thermal storage fluid is en route to a destination reservoir). For example, conduit 608 connecting the first reservoir 602 to the second reservoir 604 can pass through a heat exchanger 612 such that the thermal storage fluid can exchange enthalpy 614 with the working fluid. Similarly, conduit 610 connecting the second reservoir 604 to the third reservoir 606 can pass through heat exchanger 612 such that the thermal storage fluid can exchange enthalpy 616. The direction of enthalpy flow depends on the mode of operation, with enthalpy flowing from the working fluid to the thermal storage fluid during the charging phase and from the thermal storage fluid to the working fluid during the discharging phase. Portions of the fluid conduits can be insulated to minimize or at least reduce heat loss therefrom.

The particular arrangement and configuration of fluid conduits 608 and 610 in FIG. 6A is for illustration purposes only. Variations of the arrangement and configuration of the fluid conduits are also possible according to one or more contemplated embodiments. Such a variation is shown in FIG. 6B, where fluid conduits 628 and 630 are provided between the different reservoirs of the thermal storage system 600B. As with the configuration of FIG. 6A, one or more heat exchangers can be placed in thermal communication with the fluid conduits to enable transfer of enthalpy 614, 616. In addition, multiple fluid conduits can be provided in parallel, such that fluid flowing between the reservoirs can be distributed across the multiple conduits. Alternatively or additional, multiple fluid conduits can be provided in parallel, but with fluid flow in one conduit being opposite to that in the other conduit. For example, a return conduit may be provided between the first reservoir and the second reservoir in addition to a forward conduit such that at least some fluid can be returned to the first reservoir. The direction of the net flow between the reservoirs (i.e., the flow in the forward conduit(s) minus the flow in the reverse conduit(s)) may depend on the particular mode of operation. For example, the net flow in the charging phase may be from the colder reservoir to the hotter reservoir and reversed in the discharging phase.

Although illustrated as substantially the same size, each of the reservoirs can be a different size depending on, for example, the anticipated loading capacity. For example, the first reservoir (i.e., the cold tank) could be larger than both the second reservoir (i.e., the warm tank) and the third reservoir (i.e., the hot tank). As explained in more detail below, at the beginning of the charging phase, the first reservoir may contain substantially all of the thermal storage fluid in the thermal storage system. At the end of the charging phase, the thermal storage fluid may be transferred completely (or nearly completely) out of the first reservoir. The thermal storage fluid may thus be distributed between the second reservoir and the third reservoir, with the second reservoir holding the majority of the thermal storage fluid.

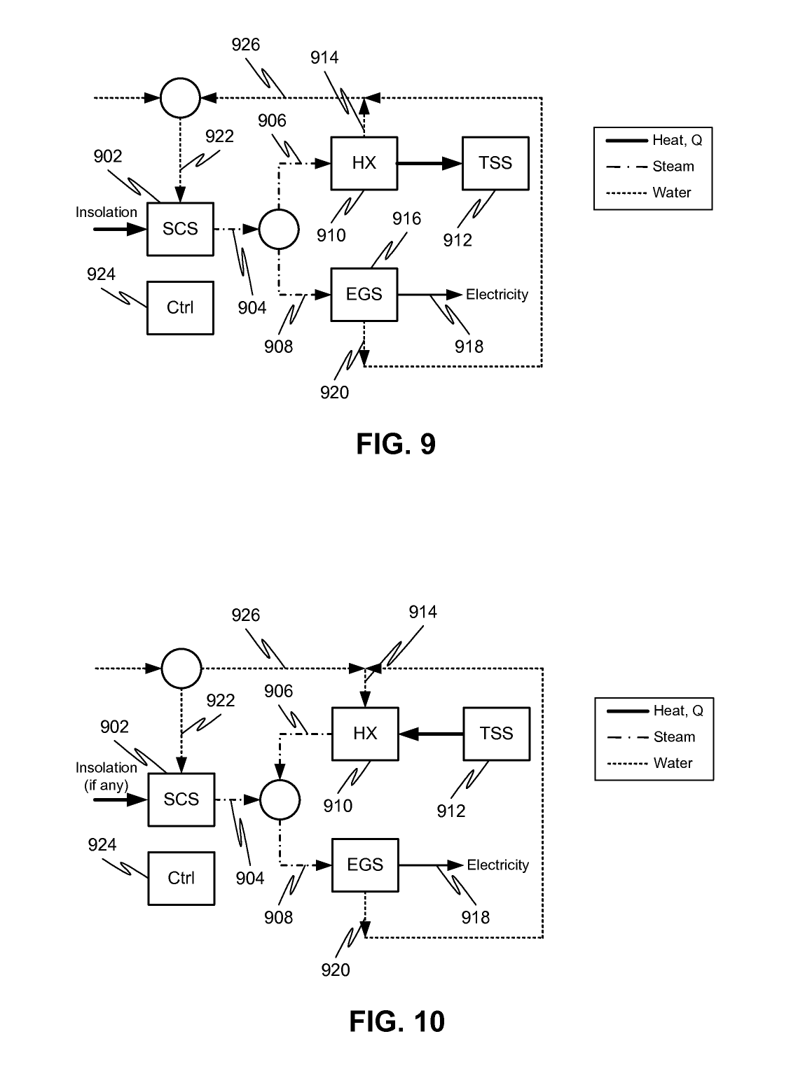

One or more pumps (not shown) can be included for moving the thermal storage fluid between reservoirs. Additional flow control components can also be provided, including, but not limited to, valves, switches, and flow rate sensors. Moreover, a controller (for example, see FIG. 9) can be provided. The controller may control the thermal storage fluid flow within the thermal storage system. The controller can include any combination of mechanical or electrical components, including analog and/or digital components and/or computer software. In particular, the controller may control the fluid flow in tandem with the working fluid to maintain a desired temperature profile within the thermal storage system for optimal (or at least improved) heat transfer efficiency. For example, during the charging and/or discharging phases, the second reservoir can be maintained at a temperature, T_{W}, above the phase change temperature of the working fluid. The phase change temperature may be the boiling temperature or the supercritical temperature at the particular pressure of the working fluid. The first reservoir can be maintained at a temperature, T_{C}, above the melting point of the thermal storage fluid such that the thermal storage fluid remains in a substantially fluid phase so as to allow pumping of the thermal storage fluid from the first reservoir. In addition, the temperature, T_{C}, of the first reservoir can be below the phase change temperature of the working fluid. The third reservoir can be maintained at a temperature, T_{H}, above the temperature of the second reservoir but below the boiling point of the thermal storage fluid. For example, a ratio of (T_{H}-T_{W}) to (T_{W}-T_{C}) is at least 1.5:1, 2:1, 2.5:1, 3:1, 3.5:1, or higher. Alternatively or additionally, a ratio of (T_{H}-T_{W}) to (T_{W}-T_{C}) is at most 10:1, 5:1, 3:1, or less. Table 1 below provides example values for temperatures and distribution of the thermal storage fluid in the various reservoirs after charging and discharging.

TABLE 1
Exemplary temperature and mass of thermal storage fluid in reservoirs.

| | | Discharged | | Charged | |
|---|---|---|---|---|---|
| Reservoir | Temp. (° C.) | Fraction | Tons | Fraction | Tons |
| Cold | 290 | X_{C} | 35,000 | ~0 | ~0 |
| Warm | 347 | ~0 | ~0 | X_{W} | 27,800 |
| Hot | 560 | ~0 | ~0 | X_{H} | 7,200 |

The thermal storage system can include a total quantity, Xₜₒₜ, of thermal storage fluid distributed between the different thermal storage reservoirs depending on the particular mode of operation and time within the mode. For example, the thermal storage system may be constructed to accommodate a total quantity of fluid of at least 100 tons, 500 tons, 1000 tons, 2500 tons, 5000 tons, 10000 tons, 50000 tons, or more. In the fully discharged state (which may be at the beginning of a charge phase), the distribution of thermal storage fluid in the thermal storage system may be such that substantially all of the storage fluid is in the cold reservoir. The cold reservoir thus has a quantity of fluid, X_{C}, that is substantially equal to Xₜₒₜ while the quantity of fluid in the warm reservoir, X_{W}, and the quantity of fluid in the hot reservoir, X_{H}, are approximately 0. In the fully charged state (which may be at the beginning of a discharge phase), the distribution of the thermal storage fluid in the thermal storage system may be such that substantially all of the storage fluid is in the warm and hot reservoirs. In particular, the warm reservoir may contain most of the thermal storage fluid. The quantify of fluid in the cold reservoir, X_{C}, is thus approximately 0, while the warm reservoir quantity, X_{W}, and the hot reservoir quantity, X_{H}, together add up to Xₜₒₜ, with X_{W} being greater than X_{H}. For example, in the fully discharged state, a ratio of X_{C} to Xₜₒₜ is at least 0.7, 0.8, 0.9, 0.95, 0.98, 0.99, or higher. In the fully charged state, a ratio of X_{C} to Xₜₒₜ is at most 0.2, 0.1, 0.05, 0.01, or less. In the fully charged state, a ratio of X_{W} to Xₜₒₜ is at least 0.5, 0.6, 0.7, 0.8, or higher. In the fully charged state, a ratio of X_{W} to X_{H} is at least 1.2, 1.5, 1.75, 2, 2.5, 3, 3.5 or higher. Alternatively or additionally, in the fully charged state, a ratio of X_{W} to X_{H} is at most 10, 5, 4, 3, or less.

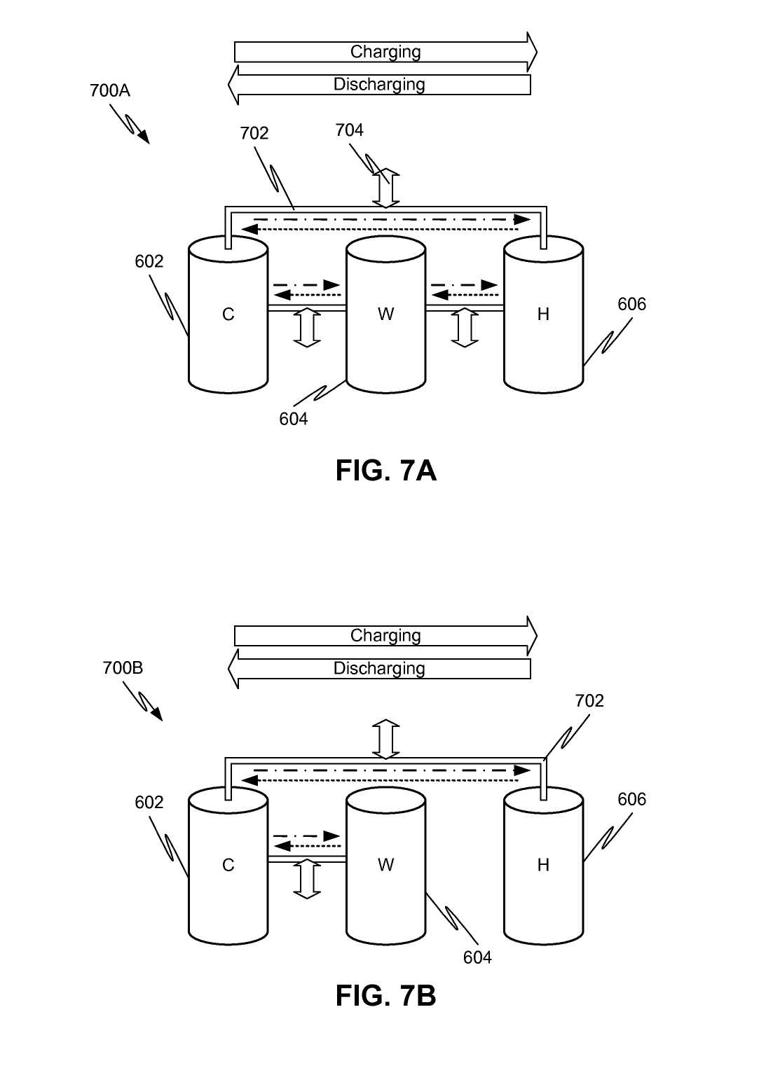

The first reservoir 602 is connected to the third reservoir 606 by way of the second reservoir 604 and the fluid conduits between the reservoirs in the configuration of FIGS. 6A-6B. Additionally or alternatively, a bypass fluid conduit 702 can be provided by which fluid in the first reservoir 602 can access the third reservoir 606 (and vice versa) without passing through the second reservoir 604. Such a configuration for the thermal storage system 700A is illustrated in FIG. 7A. As with the above-described configurations, enthalpy 704 can be transferred between the thermal storage fluid flowing in conduit 702 and a working fluid (not shown). Fluid flow out of (or into) the first reservoir 602 may be distributed between the bypass line 702 and the fluid conduit connecting the first reservoir 602 to the second reservoir 604. For example, during charging, a minority of the fluid flowing to the third reservoir 606 from the first reservoir 602 fluid may travel via bypass line 702 (i.e., without passing through the second reservoir 604) while a majority of the storage fluid (e.g., at least 70%, 80%, 90%, 95%, 99%, or higher) may travel by way of the second reservoir 604. The reverse-flow during discharging may take advantage of the bypass line 702 in a similar manner as during the charging. Alternatively, the bypass fluid conduit 702 can be provided in place of a fluid conduit connecting the second reservoir 604 to the third reservoir 606. Such a configuration for the thermal storage system 700B is illustrated in FIG. 7B. In some embodiments, during a charge phase, the thermal storage fluid flowing in bypass conduit 702 can be heated in stages. For example, in a first stage of heating, the thermal storage fluid can be heated from a first temperature substantially equal to that of the first reservoir 602 to a second temperature substantially equal to the second reservoir 604. In a second stage of heating, the thermal storage fluid can be further heated from the second temperature to a third temperature substantially equal to that of the third reservoir 606. The discharge phase can be carried out for the thermal storage system with a bypass conduit 702 in a similar manner.

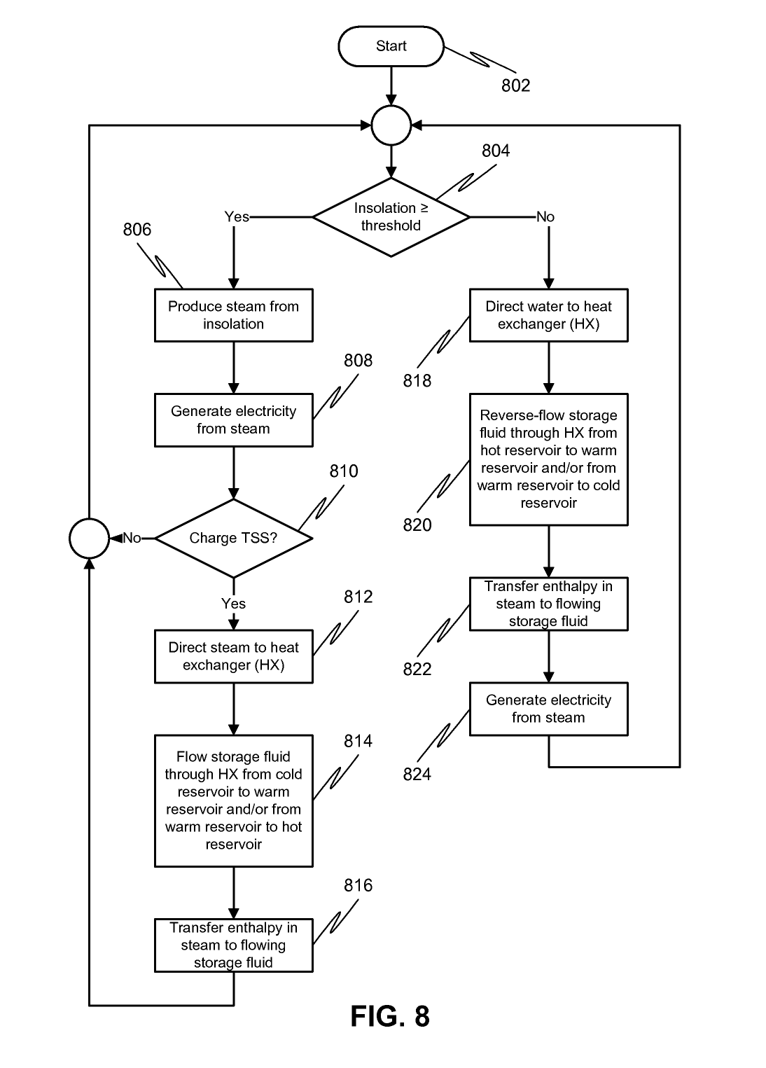

A method for operating the thermal storage system in combination with a solar collector system and an electricity generation system is shown in FIG. 8. The process starts at 802 and proceeds to 804. At 804, it is determined if the insolation is greater than a predetermined level. For example, the predetermined level may be a minimum level for the solar collector system to produce superheated steam for use by an electricity generation system. In addition, 804 may involve prediction based on real-time or simulated data. For example, the determination at 804 may take into account upcoming conditions (e.g., impending cloud cover or dusk) that would result in reduced insolation, thereby allowing the systems to adjust in time to compensate for the reduced insolation levels with minimal (or at least reduced) effect on electricity production. If sufficient insolation is present, the process can proceed to 806.

At 806, the insolation is used to heat a working fluid to induce a phase change therein. For example, when the working fluid is water, the insolation can be used to produce steam from pressurized water. Such steam production may be done in a two-stage process, with a first stage of insolation serving to evaporate the pressurized water into steam and a second stage of insolation serving to superheat the steam. To produce the steam from insolation, a concentrating solar tower system as described above with regard to FIGS. 1-5 may be used. After the steam production via insolation, the process can proceed to 808. At 808, at least a first portion of the heated working fluid can be used to produce useful work, for example, the production of electricity. When the working fluid is water, the produced steam can be used to drive a turbine to obtain useful work, for example, to drive an electricity generator. Alternatively or additionally, the produced steam can be used for another useful purpose, such as, but not limited to, fossil fuel production. In addition, as described above, the working fluid may transfer heat energy therein to another fluid for producing useful work or energy therefrom. For example, the working fluid may heat water via a heat exchanger to produce steam that is then used to generate useful work, such as by driving a steam turbine. Simultaneously or subsequently, the process can proceed to 810.

At 810, it is determined if the thermal storage system should be charged. The determination may take into account the amount of excess heat energy available and/or the current state of the thermal storage system. For example, during solar collection system startup (e.g., during the early morning hours), there may be insufficient insolation to support both electricity generation and charging of the thermal storage system. The charging may thus be delayed until sufficient insolation levels are present. In another example, charging may be unnecessary if the thermal storage system is considered fully or adequately charged. If charging of the thermal storage system is desired, the process can proceed to 812. Otherwise the process returns to 804 to repeat.

At 812, at least a second portion of the heated working fluid (i.e., a different portion from the first portion) can be directed to a heat exchanger, which is in thermal communication with the thermal storage system. Simultaneously or subsequently, the process can proceed to 814, where thermal storage fluid is flowed in the thermal storage system. In particular, the thermal storage fluid can be flowed from the first reservoir (i.e., the cold reservoir) through the heat exchanger to the second reservoir (i.e., the warm reservoir), and/or from the second reservoir through the heat exchanger to the third reservoir (i.e., the hot reservoir). Simultaneously or subsequently, the process can proceed to 816, where the enthalpy in the working fluid is transferred to the flowing thermal storage fluid by way of the heat exchanger. When the working fluid is water, superheated steam can enter the heat exchanger at one end and leave the heat exchanger at the other end as pressurized water. Enthalpy lost by the superheated steam in the phase change transition is transferred to the flowing thermal storage fluid, thereby heating the storage fluid. The heated storage fluid accumulates in the reservoirs at respective different temperatures until the first reservoir is substantially depleted. A majority of the storage fluid accumulates in the second reservoir at a lower temperature than a minority of the storage fluid in the third reservoir. At this point, the thermal storage system may be said to be fully charged and can await subsequent discharge to accommodate a low insolation condition. The process can return to 804 to repeat.

If at 804 it is determined that there is insufficient insolation, the process proceeds to 818. At 818, working fluid from a working fluid source can be directed to the heat exchanger. For example, when the working fluid is water, a pump can pressurize water from a feedwater source to the heat exchanger. Additionally or alternatively, water output from the turbine can be directed to the heat exchanger. Simultaneously or subsequently, the process can proceed to 820, where thermal storage fluid is reverse-flowed in the thermal storage system. In particular, the thermal storage fluid can be flowed from the third reservoir (i.e., the hot reservoir) through the heat exchanger to the second reservoir (i.e., the warm reservoir), and from the second reservoir through the heat exchanger to the first reservoir (i.e., the cold reservoir). Simultaneously or subsequently, the process can proceed to 822, where the enthalpy in the flowing thermal storage fluid is transferred to the working fluid by way of the heat exchanger. When the working fluid is water, pressurized steam can enter the heat exchanger at one end and leave the heat exchanger at the other end as superheated steam. Enthalpy lost by the flowing thermal storage fluid in progressing from the third reservoir to the first reservoir is transferred to the pressurized water to effect a phase change and superheating thereof. The process can then proceed to 824, where the heated working fluid from the heat exchanger can be used to produce useful work, for example, the production of electricity. When the working fluid is water, the steam from the heat exchanger can be used to drive a turbine to obtain useful work, for example, to drive an electricity generator. Such electricity production may continue until the thermal storage system is fully discharged, i.e., when a substantial majority of the thermal storage fluid is located in the first reservoir. The process can return to 804 to repeat.

Referring to FIGS. 9-10, a simplified diagram of the interaction of a solar collection system, a thermal storage system, and an electricity generation system during the charging and discharging phases is shown. In particular, FIG. 9 shows the system setup and the general flow of heat and fluids during a charging phase while FIG. 10 shows the system setup and the general flow of heat and fluids during a discharging phase. In FIGS. 9-10, a thick arrow represents energy transfer, either in the form of insolation or enthalpy; a dotted arrow represents the flow of working fluid in the lower enthalpy phase, e.g., water; and a dash-dot arrow represents the flow of working fluid in the higher enthalpy phase, e.g., steam. Although FIGS. 9-10 will be discussed with respect to water as the working fluid, it should be understood that other working fluids can also be used according to one or more contemplated embodiments.

A solar collection system 902 can receive insolation and use the insolation to evaporate pressurized water received via input line 922. The resulting steam (which may be further superheated in solar collection system 902 using the insolation) can be output from the solar collection system 902 via output line 904. The steam may be split into at least two portions: a first portion designated for thermal storage and a second portion designated for electricity generation. The relative proportions of the first and second portions may be based on a variety of factors, including, but not limited to, the amount of enthalpy in the generated steam, current electricity demand, current electricity pricing, and predicted insolation conditions. A control system 924 can be provided for regulating the operation of the solar collection system 902, the thermal storage system 912, the electricity generation system 916, the heat exchanger 910, and/or other system or flow control components (not shown). For example, the control system can be configured to execute the method shown in FIG. 8 or other methods disclosed herein.

The first portion of the steam can be directed via line 908 to an electricity generation system 916. The electricity generation system 916 can use the first portion of the steam to produce electricity and/or other useful work at 918. The steam may be condensed in the electricity generation process to produce water, which can be directed via line 920 back to the inlet line 922 of the solar collection system 902 for subsequent use in producing steam. Meanwhile, the second portion of the steam can be directed via input line 906 to a heat exchanger 910. The heat exchanger 910 is in thermal communication with a thermal storage system 912, which includes at least three thermal storage reservoirs, as described herein. Steam entering the heat exchanger 910 via input line 906 releases enthalpy (via conduction and/or convection) to the thermal storage system 912, thereby undergoing a phase change. The steam thus exits the heat exchanger 910 as water at output line 914. The water may be directed via line 914 back to the inlet line 922 of the solar collection system 902 for subsequent use in producing more steam.

When insolation is insufficient or non-existent, the setup of FIG. 9 for charging the thermal storage system 912 may transition to the setup of FIG. 10 for discharging the thermal storage system 912. In contrast to FIG. 9, the direction of feedwater is reversed such that water is input to the heat exchanger 910 via line 926. The direction of enthalpy flow is also reversed, such that heat is transferred (via conduction and/or convection) from the thermal storage system 912 to the heat exchanger 910 to heat the pressurized water flowing therethrough. The water in the heat exchanger thus undergoes a phase change and emerges from the heat exchanger 910 as steam (e.g., superheated steam) at line 906. The steam can be provided to the electricity generation system 916 via line 908 for use generating electricity at 918. During the discharging, the solar collection system 902 may continue to produce steam (via line 904) as insolation conditions allow, thereby supplementing the steam production from the heat exchanger.

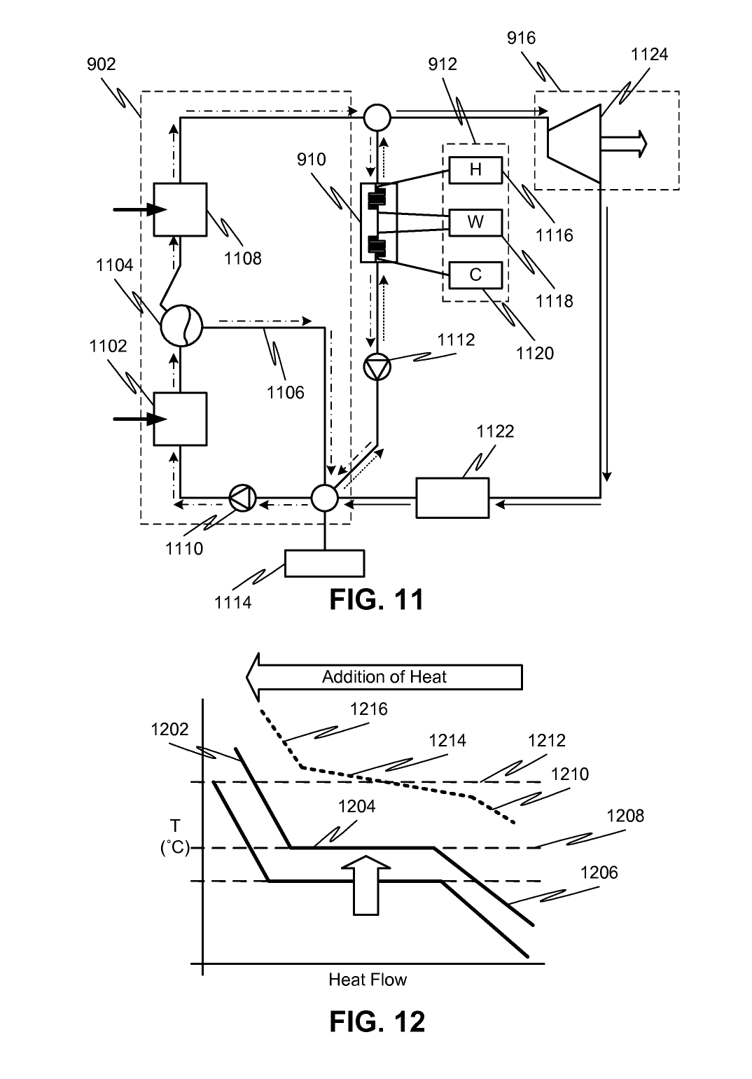

FIG. 11 illustrates various components of the systems of FIGS. 9-10 during charging and discharging of the thermal storage system 912. In FIG. 11, the flow of fluids during the charging phase is represented by dash-dot arrows while the flow of fluids during the discharging phase is represented by dotted arrows. Solid arrows represent the flow of fluids that remains the same regardless if the thermal storage system is charging or discharging. The solar collection system 902 can include a first solar receiver 1102 and a second solar receiver 1108. Pressurized working fluid in a first phase (e.g., pressurized liquid water or a pressurized mixture of liquid water and water vapor) can enter into solar receiver 1102. Insolation can cause the pressurized working fluid to undergo a phase change to a second phase (e.g., pressurized steam). The solar collection system 902 can be configured as a multi-pass boiler, where a mixture of pressurized water and saturated steam is circulated by a feedwater pump 1110 via a recirculation loop 1106. Feedwater may also be provided to the solar collection system 902 from a feedwater supply 1114. A steam separation drum 1104 can be connected to the outlet of the first solar receiver 1102 and the inlet of the recirculation loop 1106. The steam separation drum can ensure that pressurized saturated steam entering the second solar receiver 1108 is substantially liquid free. When the solar collection system is configured to generate supercritical steam, the steam separation drum 1104 and the recirculation loop 1104 may be omitted.

Steam enters the second solar receiver 1108 and is further heated by at least 50° C. (or at least 100° C., 150° C., or higher) so as to generate pressurized superheated steam (or further heated supercritical steam). A first portion of the pressurized superheated steam is sent to turbine 1124 of electricity generation system 916, for example, to generate electricity. Steam and/or water at a reduced temperature and/or pressure may exit the turbine 1124 and be returned to the solar collection system 902 for re-use. A conditioner 1122 may be provided to convert the output from the turbine into pressurized water for use by the solar collection system. A second portion of the pressurized superheated steam is sent to heat exchanger assembly 910, which can include one or more heat exchangers. Within the heat exchanger assembly 910, enthalpy of the pressurized superheated steam is used to heat the thermal storage fluid in thermal storage system 912. Storage fluid in the thermal storage system 912 may flow from first reservoir 1120 to second reservoir 1118 by way of the heat exchanger assembly 910 and from second reservoir 1118 to third reservoir 1116 by way of the heat exchanger assembly 910. After the pressurized superheated steam transfers enthalpy to the thermal storage fluid, it is at a lower thermal potential. For example, water leaving the heat exchanger assembly 910 can be pressurized liquid water having a temperature below its boiling point at that pressure. One or more pumps 1112, which may be reversible, can be used to return the pressurized water exiting the heat exchanger to the solar collection system 902 for further use. When the solar collection system is configured to generate supercritical steam, the output from the heat exchanger may be sufficiently pressurized for use by the solar collection system without pump 1112 or pump 1110. Pump 1112 may thus be omitted and/or pump 1110 may be bypassed in embodiments employing supercritical working fluid.

Within heat exchanger assembly 910, a first portion of the enthalpy transferred from the steam to the thermal storage system 912 can be used to heat a first quantity of thermal storage fluid from an initial temperature to a first destination temperature, while a second portion of the enthalpy transferred from the steam to the thermal storage system 912 can be used to heat a second quantity of thermal storage fluid from an initial temperature to a second destination temperature As the thermal storage fluid is heated, it travels between the reservoirs. For example, heating of storage fluid by the first portion of the enthalpy may occur when the storage fluid is en route from the first reservoir 1120 to the second reservoir 1118. At least some of the heating by the second portion of the enthalpy may occur when the storage fluid is en route from the second reservoir 1118 to the third reservoir 1116, and/or from the first reservoir 1120 to the third reservoir 1116 (e.g., by way of a bypass line).

When discharging is necessary, for example, due to a low insolation condition, pump 1112 may reverse direction so as to pump pressurized water from feedwater supply 1114 and/or turbine 1124 to heat exchanger 910. Within the heat exchanger assembly 910, enthalpy of the thermal storage fluid in the thermal storage system is used to heat the pressurized water. Storage fluid in the thermal storage system 912 may flow from the third reservoir 1116 to the second reservoir 1118 by way of the heat exchanger assembly 910 and from the second reservoir 1118 to the first reservoir 1120 by way of the heat exchanger assembly 910. The resulting steam can be conveyed to the turbine 1124 for use in generating electricity, for example. The steam may be at a lower pressure than that obtained via insolation generally but at substantially the same temperature obtained via insolation. The turbine 1124 may thus be configured to use the lower-pressure steam. For example, the turbine 1124 can be designed for a higher swallowing capacity so as to handle an increased steam flow rate to compensate for the decreased steam pressure. Alternatively, the turbine can include an additional steam inlet port for receiving lower pressure steam at a higher flow rate. The turbine may have a power capacity of 1 MW, 5 MW, 10 MW, 50 MW, 100 MW, 250 MW, 500 MW, or higher.

The heat exchange process with heat exchanger 910 can be a substantially isobaric process. For example, the pressure of water/steam in the heat exchanger 910 may be less than 500 bar, 400 bar, 350 bar, 300 bar, or less (but sufficiently high enough to exceed the critical point pressure for supercritical embodiments). Referring to FIG. 12, isobaric temperature-heat flow curves for a working fluid such as water are shown. For example, for sub-critical-point heating of a working fluid, the isobaric curve would have a liquid phase portion 1206, a relatively flat phase change portion 1204, and a vapor phase portion 1202. Increasing pressure tends to increase the vaporization temperature of the working fluid and moves the curves in the direction of the block arrow in FIG. 12. A generalized curve for a supercritical fluid is also shown in FIG. 12. The supercritical fluid curve has similar liquid phase 1210 and vapor phase 1216 portions to the curve; however, in the vicinity of the temperature 1212 there is no flat curve portion 1214 to account for the phase transition. The curves have not been drawn to scale or in any particular detail. Rather, they are merely for illustrative purposes only.

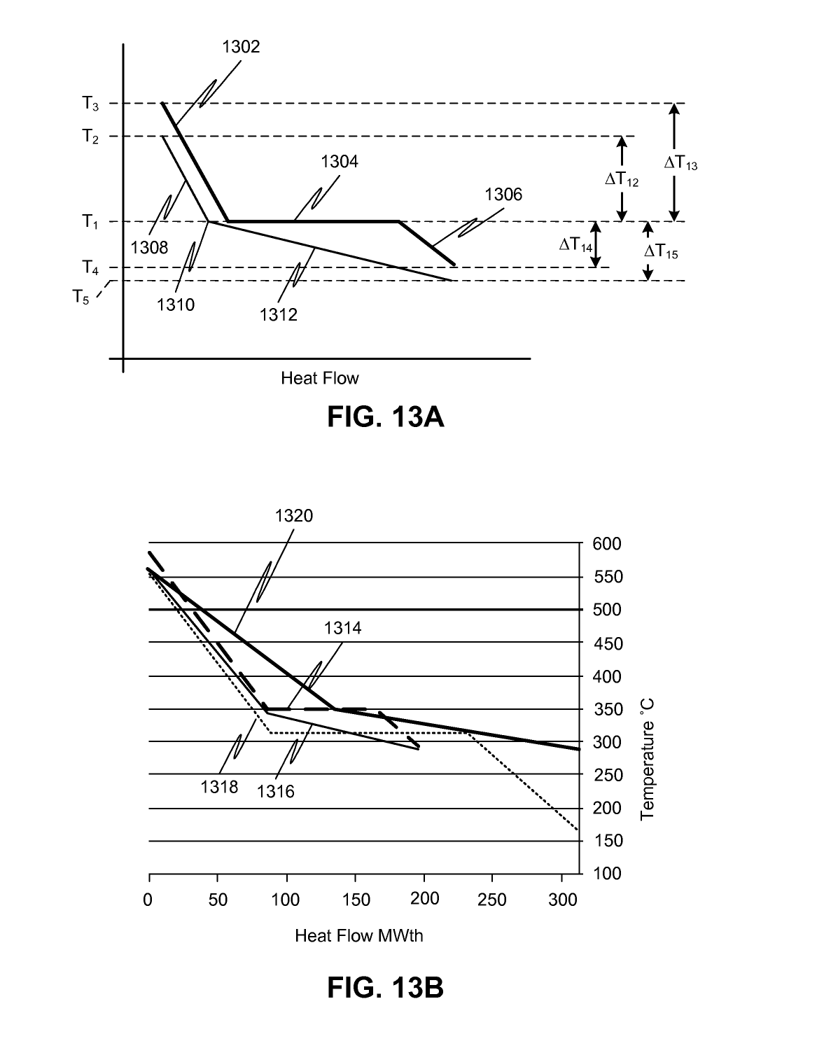

Referring to FIG. 13A, temperature-heat flow curves are shown for the working fluid and the thermal storage fluid during a charging phase. Steam at a pressure P and having an initial temperature, T₃, releases enthalpy to a thermal storage fluid to yield pressurized water (represented by portion 1306 of the curve) at a final temperature, T₄. During the release of enthalpy, the steam (represented by portion 1302 of the curve) transitions past the boiling point temperature, T₁, (represented by portion 1304 of the curve) at the designated pressure P. The enthalpy released by the steam is used to heat the thermal storage fluid from an initial temperature, T₅, to a final temperature, T₂. The initial temperature, T₅, of the thermal storage fluid may be below the final temperature, T₄ of the steam. A first portion of the heated thermal storage fluid can be heated to a first destination temperature at 1310. This may represent the thermal storage fluid that travels from the cold reservoir to the warm reservoir, as described above. This first heat exchange process may be described by the trace at 1312, which has a first slope. A second portion of the heated thermal storage fluid can be heated to a second destination temperature at T₂. This may represent the thermal storage fluid that travels from the warm reservoir to the hot reservoir, as described above. This second heat exchange process may be described by the trace at 1308, which has a second slope. The second destination temperature, T₂, can exceed the boiling point, T₁. The first slope may be different from or the same as the second slope. The ratio of the first slope to the second slope relates to the relative amounts of thermal storage fluid that is heated. If the first slope is greater than the second slope, this relates to the case wherein the second portion (e.g., the amount transferred to the hot reservoir) of the thermal storage fluid is smaller than the first portion. The ratio of the first slope to the second slope can be at least 1, 1.25, 1.5, 1.75, 2, 2.25, 2.5, 2.75, 3, or higher.

The first destination temperature at 1310 may be substantially equal to the boiling temperature, T₁, for example. In another example, the first destination temperature at 1310 may be within a tolerance of 50° C., 25° C., 10° C., or less of the boiling temperature, T₁. In still another example, the first destination temperature at 1310 may be at or within the boiling temperature, T₁, with a tolerance of at most 30%, 20%, 10% or less of a difference between an initial temperature of the steam, T₃, and a final temperature of the water, T₄. In yet another example, the first destination temperature at 1310 may be within the boiling temperature, T₁, with a tolerance of at most 30%, 20%, 10% or less of a sum of the absolute values of ΔT₁₂ and ΔT₁₅. For example, ΔT₁₃/ΔT₁₂ can be at least 0.3, 0.5, 0.7, 0.9, or higher and/or ΔT₁₄/ΔT₁₅ can be at least 0.3, 0.5, 0.7, 0.9, or higher. Alternatively or additionally, the sum of the absolute values of ΔT₁₃ and ΔT₁₅ and/or the difference between the second destination temp, T₂, and the initial temperature, T₅, can be at least 100° C., 125° C., 150° C., 175° C., 200° C., or higher.

In one or more embodiments, the pressure of the steam produced during the discharge phase is less than the pressure during the charging phase. In one particular example, the charging can be at supercritical pressures while the discharging is at subcritical pressures. Another example of a temperature-heat flow curve for charging and discharging processes is shown in FIG. 13B. Curve 1314 represents water/steam during the charging process while curve 1316 represents molten salt during the charging process, curve 1318 represents water/steam during the discharging process while curve 1320 represents molten salt during the discharging process. As should be apparent from the curves, the discharging process occurs at a lower pressure for the water/steam than the charging process.

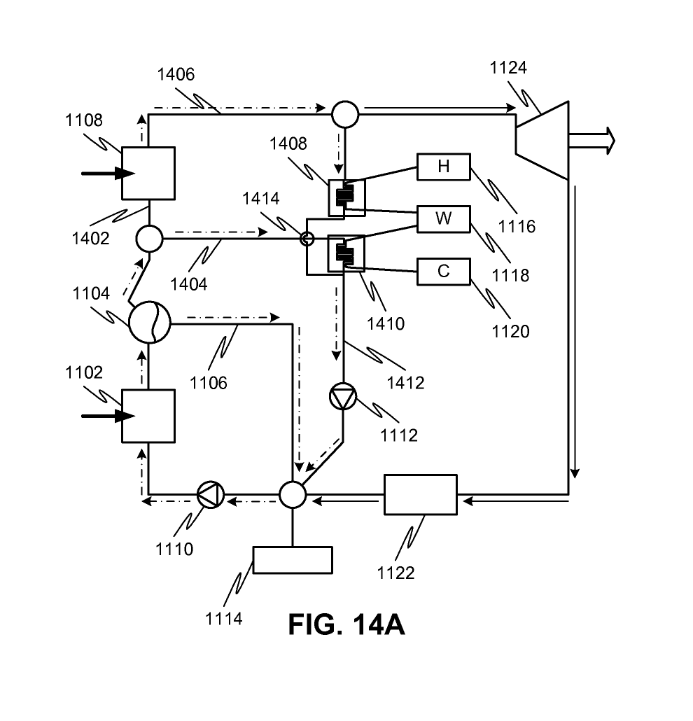

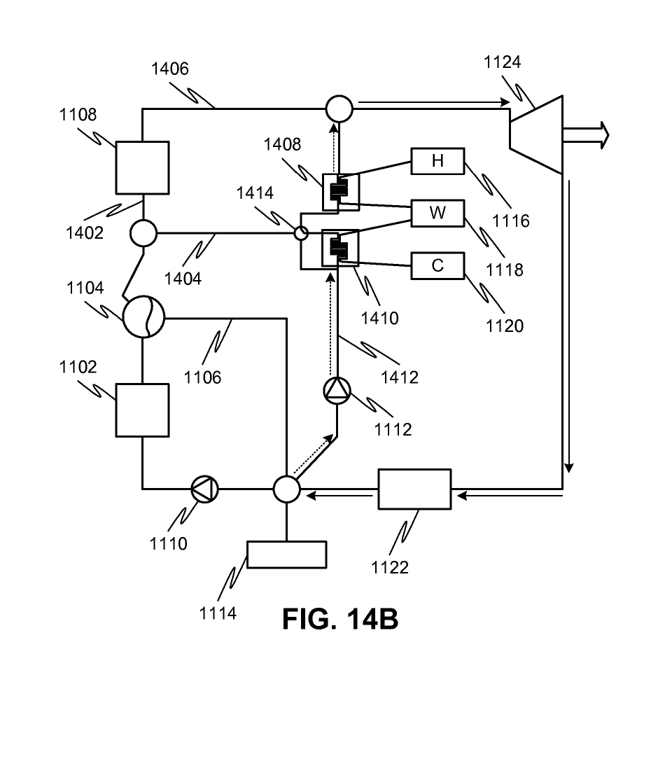

Although a single heat exchanger has been illustrated in FIG. 11, it is also possible that multiple heat exchangers can be used. The individual heat exchangers can heat different portions of the working fluid based on the desired final temperature and/or the starting temperature of the working fluid. The individual heat exchangers may interface with portions of the fluid conduits between thermal reservoirs that correspond to the desired final temperature and the starting temperature of the working fluid. Referring to FIGS. 14A-14B, a variation on the embodiment of FIG. 11 is shown. FIG. 14A refers to a configuration during charging of the thermal storage reservoirs, while FIG. 14B refers to a configuration during discharging of the thermal storage reservoirs. In particular, FIGS. 14A-14B differ from FIG. 11 in that a plurality of heat exchangers is provided instead of a single heat exchanger. Additional flow paths and flow control mechanisms are also provided to accommodate the additional heat exchanger. The different solar receivers correspond to the different heat exchangers such that steam from the first solar receiver heats thermal storage fluid associated with the first heat exchanger and superheated steam from the second solar receiver heats thermal storage fluid associated with the second heat exchanger.

Referring to FIG. 14A, the solar receiver 1102 receives insolation and uses the insolation to heat pressurized water to generate steam. Liquid in the steam is removed using steam separation drum 1104, which is connected to an inlet 1402 of the second solar receiver 1108. A line 1404 is also connected to the outlet of the steam separation drum 1104 such that a portion of the steam can be diverted from the inlet 1402 of the second solar receiver 1108 to heat exchanger 1410. In heat exchanger 1410, steam from the first solar receiver 1102 transfers enthalpy to the thermal storage fluid flowing from the first reservoir 1120 to the second reservoir 1118. The steam may or may not be condensed in the first heat exchanger 1410 and can be returned to the first solar receiver 1102 for reuse by way of return line 1412 and pump 1112. A conditioner may be provided in the return line or in another portion of the system for converting any remaining steam to water prior to introduction to the first solar receiver 1102. The steam provided to the second solar receiver 1108 is further heated by solar insolation and is provided to a turbine 1124 via output line 1406. Output line 1406 is also connected to a second heat exchanger 1408 such that a portion of the superheated steam can be diverted from the turbine 1124 to the heat exchanger 1408. In heat exchanger 1408, superheated steam from the second solar receiver 1108 transfers enthalpy to the thermal storage fluid flowing from the second reservoir 1118 to the third reservoir 1116. The steam may or may not be condensed in the second heat exchanger 1408 and can be returned to the first solar receiver for reuse by way of return line 1412 and pump 1112. A switch 1414 in line 1404 can allow the outlet steam from the second heat exchanger 1408 to flow to return line 1412 without passing through the first heat exchanger 1410. Alternatively, the outlet flow from the second heat exchanger 1408 may be provided as a second or supplemental input to the first heat exchanger 1410 to further capture heat energy in the thermal storage fluid.

Referring to FIG. 14B, thermal storage fluid flow between the thermal storage reservoirs 1116-1120 can be reversed to discharge the thermal storage system to generate steam to drive turbine 1124 when insolation alone is insufficient. Switch 1414 can be activated so as to connect the first heat exchanger 1410 to the second heat exchanger 1408. Switch 1414 can also isolate the return line 1412 from the rest of the system such that pump 1112 can provide pressurized feedwater to the first heat exchanger 1410. The feedwater can be heated in the first heat exchanger 1410 so as to evaporate the water. Steam can be provided to the second heat exchanger 1408 to further heat the steam. The superheated steam can then be provided to the turbine 1124 in place of or in supplement to superheated steam from the second solar receiver 1108 via line 1406. Other configurations that do not use switch 1414 are also contemplated. For example, various valves, pumps, and/or other flow control mechanisms can be employed to achieve selective isolation/coupling of heat exchangers as in FIGS. 14A-14B.

In one or more embodiments, the thermal storage system can include a control system, either as a shared component with the solar collection system and the electricity generation system (i.e., as part of an overall system controller) or a separate module particular to the thermal storage system (i.e., independent from but potentially interactive with other control modules). The control system can be configured to regulate flow of thermal storage fluid within and between the different storage reservoirs. For example, the control system may regulate a rate of fluid flow between the reservoirs, a timing of the fluid, an allocation parameter governing relative quantities of fluid in the reservoirs, or any other aspect governing the distribution of thermal storage fluid within the system. The flow parameters may be governed in accordance with heat transfer parameters of the flow path between reservoirs. For example, the flow parameters may be based, at least in part, on the heat transfer parameters of the heat exchanger, a temperature of the working fluid flowing through the heat exchanger, a flow rate of the working fluid flowing through the heat exchanger, or any other aspects or conditions affecting the heat transfer between the thermal storage system and the working fluid.

The control system may be configured to control other aspects of the overall system, including, for example, one or more parameters of the working fluid. For example, the control system may be configured to regulate the temperature and/or flow rate of the working fluid, at least partly in thermal communication with the heat exchanger. The control system can include any combination of mechanical or electrical components for accomplishing its goals, including but not limited to motors, pumps, valves, analog circuitry, digital circuitry, software (i.e., stored in volatile or non-volatile computer memory or storage), wired or wireless computer network(s) or any other necessary component or combination of component to accomplish its goals.

The temperature of the thermal storage fluid can also be monitored within any of the thermal storage reservoirs or combination thereof. The control system can regulate flow parameters according to the measured temperature. For example, the control system can use the measure temperatures and regulate responsively thereto in order to ensure that the temperature(s) of storage fluid in the reservoirs provide any feature disclosed herein. The measurement can be accomplished by any device known in the art. For example, the measurement can be direct (e.g., using a thermocouple or infrared sensor) or indirect (e.g., measuring a temperature in a location indicative of the fluid temperature within a reservoir).

The control system may control the various flow rate through the heat exchanger (or plurality of heat exchangers) during the charging and discharging phases to effect efficient heat transfer between the working fluid and the thermal storage fluid. For example, during the charging phase, steam at a temperature of approximately 585° C. and a pressure of approximately 170 bar may enter the heat exchanger and flow therethrough at a flow rate of approximately 317 tons per hour (tph). The steam may be reduced in temperature and/or condense in the heat exchanger so as to emerge at a temperature of approximately 295° C. and a pressure of approximately 160 bar. During the charging phase, thermal storage fluid from the cold reservoir to the warm reservoir may be controlled to flow at a higher rate than the thermal storage fluid from the warm reservoir to the hot reservoir. For example, thermal storage fluid at a temperature of approximately 290° C. from the cold reservoir may flow through the heat exchanger (or portions thereof) at a flow rate of approximately 4370 tph and arrive at the warm reservoir at a temperature of approximately 347° C. In addition, thermal storage fluid at a temperature of approximately 347° C. from the warm reservoir may flow through the heat exchanger (or portions thereof) at a flow rate of approximately 900 tph and arrive at the hot reservoir at a temperature of approximately 560° C. Of course, other temperature, pressures, and flow rates are also possible according to one or more contemplated embodiments.

Moreover, the flow rates of the thermal storage fluid can be also controlled for the bypass line (as discussed with respect to FIGS. 7A-7B above). For example, the flow rate in the bypass line 702 and in the fluid conduit 628 between the warm reservoir 604 and the cold reservoir 602 may be controlled such that the thermal storage fluid from the warm reservoir 604 and the thermal storage fluid from the hot reservoir 606 reach the cold reservoir 602 at substantially the same temperature during the discharge phase. In another example, the thermal storage fluid from the warm reservoir 604 and the thermal storage fluid from the hot reservoir 606 reach cold reservoir 602 during the discharge phase at different temperatures, which may both be less than a temperature of the thermal storage fluid remaining in warm reservoir 604.

The teachings disclosed herein may be useful for increasing solar energy generation efficiency during days of intermittent cloudy periods, maximizing electricity production and/or revenue generation of a solar electric facility, and/or meeting reliability requirements of an electric transmission network operator. In one non-limiting example, during daylight hours, (i) sub-critical or super-critical steam is generated by subjecting pressurized liquid water to insolation; (ii) a first portion of the steam (e.g., after superheating/further heating) is used to drive a turbine; and (iii) a second portion of the steam is used to heat thermal storage fluid of the thermal storage system via heat conduction and/or convection to charge the thermal storage system. At night or other period of relatively low insolation, enthalpy of the thermal storage system (i.e., when the thermal storage system is discharged) is used to evaporate and/or superheat pressurized liquid water via heat conduction and/or convection between the hotter thermal storage fluid and the cooler pressurized liquid water. This steam generated by enthalpy from the thermal storage system may be used to drive the same turbine (or any other turbine) that was driven during daylight hours by steam generated primarily by insolation. In some embodiments, the turbine driven by enthalpy of the thermal storage system operates at a lower pressure than when drive by insolation alone.

Various embodiments described herein relate to insolation and solar energy. However, this is just one example of a source of intermittent energy. The teachings herein may be applied to other forms of intermittent energy as well, according to one or more contemplated embodiments. Steam may be generated by other sources of energy and used to charge a thermal storage system. For example, fossil fuels, electricity heaters, nuclear energy, or any other source could be used to generate steam for thermal storage. Although aspects of the present disclosure relate to the production of steam using insolation for the production of electricity, it is also contemplated that the teachings presented herein can be applied to solar thermal systems that convert insolation into any of a heated working fluid, mechanical work, and electricity. Although panel-type heliostats with a central solar tower are discussed above, the teachings of the present disclosure are not limited thereto. For example, redirection and/or concentration of insolation for heating a working fluid can be accomplished using an elongated trough apparatus.

Although various embodiments of the N-reservoir solar energy storage system are explained in terms of a specific case where N is three, it is noted that greater than three reservoirs can also be used according to one or more contemplated embodiments. Moreover, some of the examples discussed herein relate to a single-phase thermal storage system for a multi-phase power generation systems. However, the teachings presented herein are not to be so limited. Rather, the teachings presented herein may be applicable to multi-phase thermal storage systems and/or single-phase power generation systems, according to one or more contemplated embodiments. Moreover, while specific examples have been discussed with respect to using water/steam as a working/heat transfer fluid, it is further contemplated that other working/heat transfer fluids can be used as well. For example, salt-water and/or pressurized carbon dioxide can be used as a working/heat transfer fluid. Other working/heat transfer fluids are also possible according to one or more contemplated embodiments. In addition, while specific examples have been discussed with respect to using molten salt and/or molten metal as the thermal storage fluid, it is contemplated that other types of thermal storage fluids can be used as well.

It will be appreciated that the modules, processes, systems, and sections described above can be implemented in hardware, hardware programmed by software, software instruction stored on a non-transitory computer readable medium or a combination of the above. A system for controlling the thermal storage system, the solar collection system, and/or the electricity generating system can be implemented, for example, using a processor configured to execute a sequence of programmed instructions stored on a non-transitory computer readable medium. The processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive, etc.

Furthermore, the modules, processes, systems, and sections can be implemented as a single processor or as a distributed processor. Further, it should be appreciated that the steps discussed herein may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below, but not limited thereto. The modules, processors or systems described herein can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example. Moreover, embodiments of the disclosed method, system, and computer program product can be implemented in software executed on a programmed general purpose computer, a special purpose computer, a microprocessor, or the like.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, etc. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of solar collection, thermal storage, electricity generation, and/or computer programming arts.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, system, methods, and devices for solar energy storage using three or more reservoirs. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. A method of generating electricity using insolation, comprising:
at a first operating period:
generating steam using insolation;
using a portion of the generated steam to drive a turbine so as to produce electricity;
directing another portion of the generated steam to a heat exchanger in thermal communication with first through third thermal reservoirs; and
at a same time as said directing another portion, flowing a storage fluid from the first reservoir through the heat exchanger to the second reservoir and from the second reservoir through the heat exchanger to the third reservoir such that enthalpy in said another portion of the generated steam is transferred to the storage fluid by way of the heat exchanger; and
at a second operating period:
reverse-flowing the storage fluid from the third reservoir through the heat exchanger to the second reservoir and from the second reservoir through the heat exchanger to first reservoir such that enthalpy in the storage fluid is transferred by way of the heat exchanger to generate steam; and
using the steam generated by said reverse-flowing to drive said turbine to produce electricity,
wherein a temperature of the third reservoir is maintained higher than a temperature of the second reservoir, and a temperature of second reservoir is maintained higher than a temperature of the first reservoir.

2. The method of claim 1, wherein the storage fluid includes at least one of a molten salt and a molten metal.

3. The method of claim 1, wherein an insolation level during the first operating period is greater than an insolation level during the second operating period.

4. The method of claim 1, wherein flow rates during said flowing and said reverse-flowing are controlled so as to maintain respective temperatures of the first through third reservoirs.

5. The method of claim 1, wherein, at a start of the second operating period:
the first reservoir has a temperature greater than a melting point of the storage fluid and less than a boiling point of pressurized water,
the second reservoir has a temperature greater than both the melting point of the storage fluid and the boiling point of pressurized water, and
the third reservoir has a temperature greater than the temperature of the second reservoir and less than a boiling point of the storage fluid.

6. The method of claim 5, wherein, at the start of the second operating period, the temperature of the first reservoir is approximately 290° C., the temperature of the second reservoir is approximately 347° C., and the temperature of the third reservoir is approximately 560° C.

7. The method of claim 1, wherein, at the start of the second operating period, the storage fluid is distributed between the first through third reservoirs such that the first reservoir is substantially empty and most of the storage fluid is in the second reservoir.

8. The method of claim 1, wherein, at the start of the first operating period, the storage fluid is distributed between the first through third reservoirs such that substantially all of the storage fluid is in the first reservoir and the second and third reservoirs are substantially empty.

9. The method of claim 1, wherein the turbine operates at a lower pressure during the second operation period than the first operating period.

10. The method of claim 9, wherein the production of electricity by the turbine during the first operating period uses steam at a pressure of approximately 170 bar, and the production of electricity by the turbine during the second operating period uses steam at a pressure of approximately 100 bar.

11. The method of claim 1, wherein the reverse-flowing at the second operating period includes:
flowing the storage fluid from the second reservoir through the heat exchanger to the first reservoir so as to evaporate water flowing through the heat exchanger; and
flowing the storage fluid from the third reservoir through the heat exchanger to the second reservoir so as to superheat steam flowing through the heat exchanger.

12. The method of claim 1, wherein the first through third reservoirs are one of a fluid tank and a below grade pool.

13. The method of claim 1, wherein the storage fluid is maintained in a liquid phase in the storage reservoirs.

14. The method of claim 1, wherein the generating steam at the first operating period includes reflecting insolation onto a central solar receiver using a plurality of heliostats.

15. A system for generating electricity from insolation, the system comprising:
a solar collection system constructed so as to generate steam from insolation;
a thermal storage system including first through third thermal storage reservoirs;
an electricity generating system including a turbine that uses steam to generate electricity, the electricity generating system being coupled to the solar collection system so as to receive generated steam therefrom; and
a heat exchanger by which the solar collection system and the thermal storage system are thermally coupled to each other such that enthalpy in fluid in one of the solar collection and thermal storage systems can be transferred to fluid in the other of the solar collection and thermal storage systems,
wherein the first through third storage reservoirs are connected in order such that fluid flowing between the first and second reservoirs and between the second and third reservoirs passes through the heat exchanger.

16. The system of claim 15, further comprising a control system that controls the thermal storage system, the controller being configured to:
at a first operating period, control the thermal storage system to flow a storage fluid from the first reservoir through the heat exchanger to the second reservoir and from the second reservoir through the heat exchanger to the third reservoir such that enthalpy is transferred to the storage fluid by way of the heat exchanger; and
at a second operating period, control the thermal storage system to flow the storage fluid from the third reservoir through the heat exchanger to the second reservoir and from the second reservoir through the heat exchanger to first reservoir such that enthalpy in the storage fluid is transferred from the storage fluid by way of the heat exchanger

17. The system of claim 16, wherein the controller is configured to control flow rates during said flowing at the first and second operating periods so as to maintain a temperature of the third reservoir above a temperature of the second reservoir and the temperature of the second reservoir above a temperature of the first reservoir.

18. The system of claim 17, wherein:
the first reservoir has a temperature greater than a melting point of the storage fluid and less than a boiling point of pressurized water,
the second reservoir has a temperature greater than both the melting point of the storage fluid and the boiling point of pressurized water, and
the third reservoir has a temperature greater than the temperature of the second reservoir and less than a boiling point of the storage fluid.

19. The system of claim 18, wherein, the temperature of the first reservoir is approximately 290° C., the temperature of the second reservoir is approximately 347° C., and the temperature of the third reservoir is approximately 560° C.

20. The system of claim 16, wherein, the controller is configured to control the thermal storage system such that:
at the start of the first operating period, the storage fluid is distributed between the first through third reservoirs such that substantially all of the storage fluid is in the first reservoir and the second and third reservoirs are substantially empty; and
at the start of the second operating period, the storage fluid is distributed between the first through third reservoirs such that the first reservoir is substantially empty and most of the storage fluid is in the second reservoir.

21. The system of claim 15, wherein the first through third reservoirs are one of a fluid tank and a below grade pool.

22. The system of claim 15, wherein the first through third reservoirs are constructed to contain at least one of a molten salt and a molten metal.

23. The system of claim 15, wherein solar collection system includes a central solar receiver and a plurality of heliostats configured to reflect insolation onto the solar receiver.

24-43. (canceled)
